(19) United States
(12) Patent Application Publication
(10) Pub. No.: US 2005/0063079 A1
(43) Pub. Date: Mar. 24, 2005

(54) Apparatus and methods relating to concentration and shaping of illumination

(76) Inventors: Nicholas B. MacKinnon, Vancouver (CA); Mathieu Quatrevalet, Paris (FR); Joshua King, Newcastle, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/893,132

(22) Filed: Jul. 16, 2004

Related U.S. Application Data
(60) Provisional application No. 60/488,130, filed on Jul. 16, 2003.

(51) Int. Cl. G02B 5/10

(52) U.S. Cl. 359/853

(57) ABSTRACT

Optical systems comprising apparatus and methods for redirecting and concentrating illumination from a source of illumination such as an arc lamp or optical fiber into a narrow line while conserving much of the useful energy of the light source. Light from the point source is optically directed into a collimated beam which is then optically focused in one axis into a substantially line shaped beam of illumination at the point of focus. At the point of focus an optical element exchanges the converging and collimated angles of the beam over a period approximately less than or equal to the width of the focused beam. The beam of light which is now collimated in the short axis of the focused beam and diverging in the long axis of the focused beam can be further focused or directed into a narrow line of light which can be used for projection, illumination scanning or by systems for wavelength conditioning wavelength.

### CROSS-REFERENCE TO RELATED APPLICATIONS

The present application claims priority from U.S. provisional patent application No. 60/488,130, filed Jul. 16, 2003, which is incorporated herein by reference in its entirety and for all its teachings and disclosures.

### BACKGROUND

For illumination to be effective, light must be efficiently directed from the illumination source to the area to be illuminated. This direction is usually accomplished through various optical components that may be as simple as a metal reflector behind a fluorescent tube or as complex as the optics of a digital cinema projection system.

It is well known that large illumination sources such as fluorescent tubes or large glowing filament lamps are difficult to direct effectively because their large size makes them difficult to focus into optical systems such as spot lights, projection systems, or clinical endoscopy illumination systems. For illumination systems such as these, the illumination source most often chosen is the arc lamp, which generates intense illumination energy from an extremely small volume.

Illumination sources that provide illumination with energy emitted from a small, intense volume or surface are known as point sources. Examples of point sources are light emanating from an optical fiber, or light emitted from an arc lamp.

For many illumination applications arc lamps, which create a small, and approximately spherical, source of energy, are well suited, but for certain applications a non-spherical geometry is more desirable. For example, for some imaging and printing applications it is more useful to have illumination structured as an intense line of light rather than a broad field of illumination. For applications in which the illumination light is spectrally conditioned using wavelength dispersion this line shape is particularly useful.

Changing the shape of an intense light source from a spherical volume to an approximately cylindrical shape or an elongated elliptical shape, requires optical components to focus and redirect the light from the source and apertures and stops to prevent out-of-focus light that cannot be used effectively from propagating. Often these optical solutions result in loss of useful energy, reducing illumination intensity and energy efficiency.

The science of spectroscopy also works with the shaping and redirecting of light but for a different purpose—measurement of the distribution of photon energies that make up the light emitted or reflected from sources. Spectrometers typically try to constrain the light they are measuring into a line shape that is then spectrally dispersed and measured. Tall, narrow apertures, known as slits, are often used to do this.

Traditional illumination methods have not ordinarily required light that is highly focused in one direction, but new techniques of imaging, such as line scanning of web presses or spectrally tunable light sources employing wavelength dispersive elements have created a need for such illumination systems.

Thus, there has gone unmet a need for lighting systems and luminaires that can provide light output shaped into a high intensity narrow line, that can be usefully directed to illuminate an area or another component of a lighting or imaging system. The present invention provides optical apparatus and methods to provide these and other advantages.

### SUMMARY

The present invention comprises optical systems that provide light projected with high intensity and into a substantially narrow line. These lines of high intensity light can be used for a variety of purposes. A particularly useful purpose is the wavelength conditioning of illumination discussed in patent application PCT/CA02/00124.

While traditional porro prisms arrayed and set to deflect a beam at 45 degrees can be useful for concentrating general diffuse illumination for a spectrometer, this type of optical arrangement is not as appropriate for high intensity illumination using bright point sources.

A porro prism is a prism that reflects light by two total internal reflections. Total internal reflection is the reflection of most of the light being transmitted though an optical medium at an optical boundary surface due to refractive index differences between the material of the optical medium and the external medium.

Refractive index is a measure of the ability of a material to bend light relative to air. Typically a porro prism is a 45-90-45° reflecting prism with surfaces that form a 90° angle that can reflect a light beam through a total angle of 180°, but a porro prism may be any combination of angles with a 90 degree vertex such as a 30-90-60° prism. These prisms are commonly used in prism binoculars.

Multiple single prisms can be combined in a one or two dimensional array by assembly or can be fabricated as a single piece by machining or casting. They can be made from any material that transmits light such as a glass, a crystal, a plastic or a liquid.

While prisms have certain utility for redirecting diffuse sources of light, one suitable method of creating a retro-reflector for a source of light such as an arc lamp is a first surface retro-reflector

A retro-reflector is a reflector that generally directs incident light backwards towards its source on a path substantially parallel to its angle of incidence, for example by two sequential planar reflections set at about 45 degrees to the angle of incidence. The angle of the reflecting planes can be adjusted to redirect light at other angles, as in the safety reflector facets found in reflectors common on bicycles or slow moving vehicles.

A first surface retro-reflector can be advantageous for some embodiments because it is typically not subject to changes in angle of incidence due to refraction at the surface of a porro type prism, not subject to losses due to the critical angle at each of the reflecting surfaces, which increases the optical efficiency of reflection, can be fabricated more easily than a prism which requires three high quality transmissive or reflective surfaces, whereas the first surface retro-reflector usually has only two high quality surfaces to be fabricated, and the first surface retro-reflector can absorb less energy since light does not traverse its structure, but bounces off the surface. Furthermore a reflective array does not have the problem of managing light that is dispersed as stray light in the system due to critical angle losses. Critical angle losses are losses that occur when light significantly exceeds the angle of incidence for total internal reflection for a prism and starts to be transmitted out of the prism, out of the desired optical path and into the system as stray light.

Different optical systems can be employed that can take advantage of the high degree of collimation available from an arc lamp or other desired light source. Careful attention to the relative angles of the surfaces making up the retro-reflector can improve optical efficiency of an illumination or lighting system

In one aspect, this invention provides reflective mirror arrays enhanced for different angles of incidence to increase optical efficiency when lamps with circular, elliptical or other-shaped sources of light are directed into a line geometry. It further provides a method for selecting the angular design of a reflective mirror array for a desired angle of incidence and/or a desired angle of redirection. A further consideration in creating an optical system to manage illumination with high intensity arc lamps and other hot light sources is the ability of the system to withstand heat. Transmissive optics usually absorb some energy in the form of heat and this can be a particular problem where energy is concentrated in some optical components.

Nevertheless, transmissive optics and other optical configurations can be used as desired for certain embodiments. Moreover, when desired it is possible to improve the performance of prism retro-reflectors by attention to critical angles of the prism for given angles of incidence of light. Design of a prism array enhanced for steeper angles of incidence to the prism array can improve the optical efficiency of a prism array used to rotate and exchange divergence angles of a focused light source. For improved efficiency different angular construction of the prisms making up the array can be used for each angle of incidence.

This invention provides improved prism arrays enhanced for different angles of incidence to increase optical efficiency when lamps with circular, elliptical or other-shaped sources of light are directed into a line geometry. It further provides methods for selecting the design angles of a prism array for a desired angle of incidence and/or a desired angle of redirection.

This invention provides reflective mirror arrays enhanced for different angles of incidence to increase optical efficiency when lamps with circular, elliptical or other-shaped sources of light are directed into a line geometry. It further provides methods for selecting the angular design of a reflective mirror array for a desired angle of incidence and/or a desired angle of redirection.

In one aspect, the present invention provides an optical concentrator comprising a plurality of optical elements optically connected along a light path, the elements comprising a focusing element configured to focus collimated light substantially in only one axis to form a beam having an elongated cross-section at a focal point of the focusing element, the focusing element located upstream from a piece-wise rotation optical element configured to rotate in a piece-wise manner at least a substantial portion of the beam such that collimated and non-collimated axes of the beam can be changed in position to provide a beam that can be collimated along a desired axis of the beam other than the long axis and converging/diverging along a second desired axis of the beam other than the short axis.

In some embodiments, the concentrator further can comprise a collimator located upstream from focusing element. The piece-wise rotation optical element can be configured to rotate the substantial portion approximately 90 degrees such that the collimated and non-collimated axes can be exchanged in position to provide a beam that is collimated along the short axis of the beam and converging/diverging along the long axis of the beam.

The piece-wise rotation optical element can comprise an array of first surface reflectors configured as approximately 90 degree retro-reflectors, an array of prisms configured as porro type approximately 90 degree retro-reflectors, a transmissive array or any other desired array of piece-wise optical rotational elements. The piece-wise rotation optical element can have an about 90 degree vertex of the retro-reflector, which can be set at approximately 45 degrees to the collimated axis of the focused beam directed onto the array. The piece-wise rotation optical element can be tilted to direct the reflecting beam away from the source of illumination.

The concentrator further can comprise a second focusing element downstream from the rotation optical element, the second focusing element configured to focus a light beam emitted from the piece-wise rotation optical element to form a narrow line, or other desired shape, in cross-section. The concentrator can also comprise an optical shaping element downstream from the rotation optical element, the optical shaping element configured to spread a light beam emitted from the piece-wise rotation optical element to form a narrow substantially rectangular shaped beam, and the concentrator can comprise a scanner configured to scan a light beam emitted from the piece-wise rotation optical element to illuminate a target, a different optical system, or other element as desired.

The piece-wise rotation optical element can comprise a transparent prism array wherein a flat surface of the prism can be directed toward the source of illumination and a back surface of the prism can comprise triangular surface elements. The piece-wise rotation optical element can be substantially flat, substantially curved, or otherwise shaped as desired. At least two of the optical elements can be combined into a single unit.

In another aspect, the present invention comprises lighting systems that provide a light beam having a long axis and a short axis and that can be collimated along a desired axis of the beam other than the long axis and converging/diverging along a second desired axis of the beam other than the short axis. The system can comprise, a light source configured to provide a light beam; a first optical element disposed and configured to accept and collimate the light beam to provide a collimated light beam; a second optical element disposed and configured to focus the collimated light beam substantially in only one axis to form a substantially line-shaped beam; and, a third optical element disposed and configured to configured to rotate at least a substantial portion of the substantially line-shaped beam a desired number of degrees such that the collimated and non-collimated axes can be changed in position to provide a beam that can be collimated along a desired axis of the beam other than the long axis and converging/diverging along a second desired axis of the beam other than the short axis.

In a further aspect, the present invention comprises a light beam produced using the systems herein. Also provided are treated light beams from a light source, and the beam having a substantially elongated cross-section comprising a short first axis and a long second axis, wherein the beam can be collimated along a desired axis of the beam other than the long axis and converging/diverging along a second desired axis of the beam other than the short axis, and wherein the light beam can comprise substantially all of the light emanated from the light source along the light beam.

The axes of the beam can be at 900 to each other and the beam can be collimated along the short axis and converging/diverging along the long axis. The long axis can exceed the short axis by a ratio of at least about 10, 100 or more as desired.

In still a further aspect, the present invention comprises an optical piece-wise mirror rotation array comprising an array of piece-wise rotation mirror elements configured such that light impinging on a front surface of the array can be piece-wise rotated by the array of piece-wise mirror elements then emitted from the front surface of the array.

In yet a further aspect, the present invention comprises an optical piece-wise transmissive rotation array comprising an array of piece-wise rotation elements configured such that light impinging on a front surface of the array can be piece-wise rotated by the piece-wise elements then emitted from at least one of a back surface and a side surface of the array.

The piece-wise rotation elements can comprise first surface mirrors, transmissive prisms, or both first surface mirrors and transmissive prisms, or other optical elements as desired.

The piece-wise elements can be substantially linearly shaped, rectangular, square, triangular, hexagonal, asymmetric. The piece-wise elements can comprise a protective coating and/or a filter coating, for example a coating configured to substantially block or pass short wavelengths, long wavelengths or selected bands of electromagnetic radiation. The optical surfaces within the piece-wise elements can be adjustable relative to each other, and the elements can be adjustable relative to each other.

The array can be operably connected to a computer comprising computer-implemented programming, the programming configured to control the piece-wise elements at least one of as a unit, individually, or in patterns such as sequential, complementary patterns or stationary patterns.

In other aspects, the present invention includes methods of making and of using the devices, systems, etc., discussed herein, and methods of making and using the unique beams of light discussed herein. For example, the present invention can comprise methods of rotating a collimated light beam comprising focusing the collimated light beam substantially in only one axis to form a collimated beam having an elongated cross-section at a focal point of the focusing element, then piece-wise rotating the light beam such that collimated and non-collimated axes of the beam are changed in position to provide a rotated collimated beam that is collimated along a desired axis of the beam other than a long axis of the elongated cross-section and converging/diverging along a second desired axis of the beam other than a short axis the elongated cross-section.

The rotated collimated beam can can comprise at least about 70%, 80%, 90%, 95%, 98%, or substantially all of the light of the collimated beam. The methods can further comprise collimating a non-collimated light beam to provide the collimated light beam, and providing light from a light source to provide the light beam to be collimated and rotated. The light can be from a point light source, and non-point light source, a laser, an arc lamp, an LED, or any other desired light source. The methods can also comprise filtering the light in conjunction with the collimating and/or piece-wise rotating of the light beam, and other wise treating the light beam as desired to affect the characteristics of the light beam.

In other aspects, the present invention includes methods for enhancing the performance of a first surface reflector reflective piecewise rotational array when the beam is to be folded by an angle θ comprising determing suitable angles of the reflecting planes of the array by calculating the microarray angle a according to the equation:

$$α = \frac{1}{2} ( {tan}^{- 1} ( \frac{\sqrt{2}}{tan ( θ )} ) )$$

In other aspects, the present invention includes methods for enhancing the performance of a total internal reflectance prism type reflective piecewise rotational array when the beam is to be folded by an angle θ comprising determing suitable angles of the reflecting planes of the array by calculating the microarray angle α according to the equation,

$$α = \frac{1}{2} ( {tan}^{- 1} ( \frac{\sqrt{2}}{tan ( θ )} ) )$$

where the angle θ is replaced in the calculation by the effective angle θ′ for the prism material determined by the equation

$${θ}^{′} = {sin}^{- 1} ( \frac{sin ( θ )}{n} ) .$$

These and other aspects, features and embodiments are set forth within this application, including the following Detailed Description and attached drawings. The present invention comprises a variety of aspects, features, and embodiments; such multiple aspects, features and embodiments can be combined and permuted in any desired manner. In addition, various references are set forth herein that discuss certain apparatus, systems, methods, or other information; all such references are incorporated herein by reference in their entirety and for all their teachings and disclosures, regardless of where the references may appear in this application.

### BRIEF DESCRIPTION OF THE FIGURES

FIG. 1 depicts a top view and a side view of a schematic diagram of an exemplary system embodying an optical concentrator as discussed herein. The z axis coincides with the optical axis of the system. In practice, the reflective element 10 typically redirects the beam in three dimensions so the z direction of the beam entering element 10 may not be the same direction as the z direction of the beam leaving element 10. This is difficult to depict in two dimensions, so the z directions before and after element 10 have been drawn coincident in this figure to illustrate the principle of operation.

FIG. 2 depicts a schematic of a retro-reflecting microarray element. The retro-reflecting microarray element can be for example a piece-wise rotation mirror array or a prism array.

FIG. 3 depicts schematically the paths of marginal light rays impinging on a retro-piece-wise rotation mirror array element at different angles of incidence.

FIG. 4 depicts schematically geometrical relationships of light rays impinging on a piece-wise rotation mirror array. FIG. 4a shows a marginal ray whose first reflection is off the longer reflecting side of the microarray. FIG. 4b shows a marginal ray whose first reflection is off the shorter reflecting side of he microarray.

FIG. 5 is a graph showing plots of the geometrical efficiency of a piece-wise rotation mirror array as a function of angle of incidence for different angles of the reflective sides of the microarray.

FIG. 6 depicts schematic diagrams regarding a mathematical derivation of the relationship between the angles of incidence on a microarray that is tilted in order to fold the optical path. FIG. 6a schematically depicts a top view of the microarray. FIG. 6b schematically depicts a front view of the microarray. FIG. 6c is a diagram of the angles of incidence in the normal plane of the microarray. FIG. 6d is a diagram of the projection of the angles of incidence in FIG. 6c onto the plane of incidence.

FIG. 7 is a graph showing plots of the geometrical efficiency of a tilted piece-wise rotation mirror array as a function of the global angle of incidence for different angles of the reflective sides of the microarray.

FIG. 8 shows graphs of plots of the geometrical efficiency of a prism microarray as a function of angle of incidence for different angles of the reflective sides of the microarray. The graph in FIG. 8a is calculated for a prism array whose refractive index is 1.55, which is the refractive index of BK7 glass. The graph in FIG. 8b is calculated for a prism array whose refractive index is 1.7.

FIG. 9 depicts a side view of a schematic diagram of a transmissive optical piecewise rotational array comprising a plurality of piece-wise elements, wherein surfaces within the piece-wise elements comprise both transmissive and mirror or reflective surfaces.

### DETAILED DESCRIPTION

The present invention comprises components for conditioning light emitted by a desired light source such as an arc lamp, filament lamp, light emitting diode (LED) or an optical fiber, to direct that illumination such that it may be precisely focused into a narrow line.

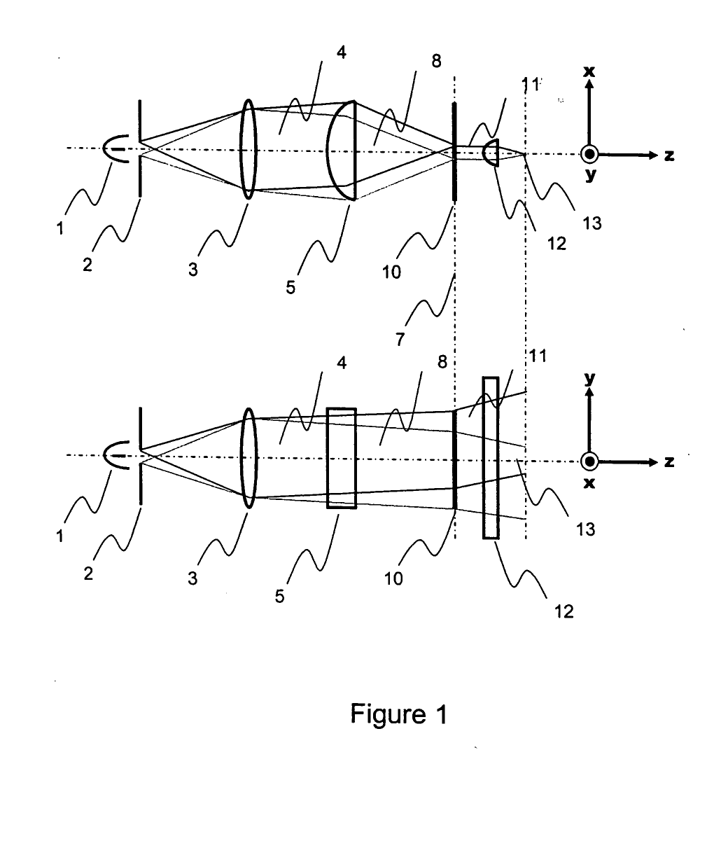

One embodiment is depicted in top and side views in FIG. 1. Light from arc lamp or other point source 1 or other light source as directed as a beam through aperture stop 2. Aperture stop 2 blocks out of focus light to prevent it from propagating through the system and degrading optical performance. In-focus light is collected by collimating lens 3 and the collimated light 4 is directed to cylindrical lens 5. Collimated light in which the rays of light making up the beam are substantially parallel.

Cylindrical lens 5 focuses the light in only the horizontal axis resulting in convergence of the collimated beam into a line of light with a mean angle of incidence at focal plane 7. While focal plane 7 comprises a rotation optical element that can be reflective or transmissive as in the embodiment shown. In some embodiments the rotation optical element can is transmissive, such as a double porro prism (with the typical 45° angle of rotation or other angles as desired), or other transmissive configurations as desired. Piece-wise rotation mirror array 10 is positioned at focal plane 7 and oriented to reflect the beam 8 incident on its surfaces while rotating the angles of convergence or divergence of portions of the line of light in a piece-wise fashion. If desired, the rotation optical element can rotate the light in a linear-stepwise fashion, a pixel-like fashion, or otherwise as desired. Moreover, the rotation can be through about 90 degrees, but can also be other rotations if desired. The size of the pixels/portions so rotated is determined by the spatial period of the piece-wise rotation mirror array. Cylindrical lens 12 focuses the reflected beam 11 again only in the horizontal axis resulting in a narrowing of the line-shaped beam 11 to form a very narrow line of light 13. In some embodiments, the “pieces” of the piece-wise rotation array are from about 10-100 μm to about 2-3 mm.

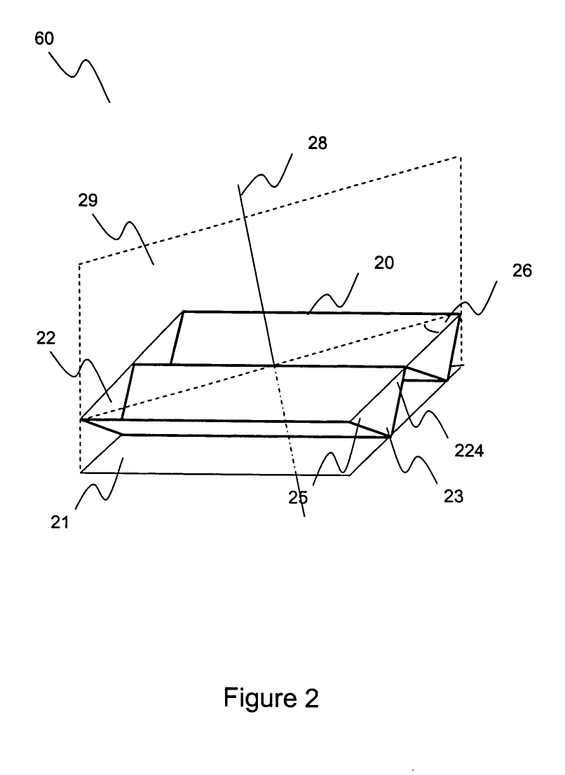

Piece-wise rotation mirror array 10 depicted in FIG. 2 comprises an optical surface 20 that is coated with a highly reflective coating to form a mirror like surface. The surface 20 is a periodic array of tilted planes that can resemble a serrated metal file or, in one profile, a saw-tooth shape, or other similar configurations that provide the desired effects. Viewed in three dimensions it can have a structure similar to a diffraction grating or a washboard. The dimensions and angles of these tilted planes can be adjusted to enhance the efficiency of the light concentrator for capturing and directing light.

The serrated or saw tooth profile of piece-wise rotation mirror array 10 comprises a series of peaks and valleys connected by planes set at a rising angle and a falling angle. The plane 21 defined by the lowest position of the valleys and the plane 22 defined by highest position of the peaks are substantially parallel. The relative angular orientation of plane 22 with the optical axis 28 of the system is defined as the normal plane 29 of the element and is used as a reference for defining the angles of the rising and falling angles of the planes forming the peaks and valleys. The angle 23 between rising angle 24 and falling angle 25 is preferably about 90 degrees. The angle 26 between falling angle 25 and the normal plane 29 can be varied to suit the optical geometry of the system in which it is employed. For a particular mean angle of incidence of a light beam there is an optimum angle 25 that can be determined. Because of geometrical invariance rising angle 24 will be 90 degrees minus falling angle 25, if the angle between the rising and falling angles is 90 degrees.

Although the piece-wise rotation mirror array 10 in one embodiment is of unitary construction it can be thought of as an array of substantially triangular prisms with one rectangular face parallel to normal plane 29 and the other two rectangular faces comprising the rising plane and falling plane. Other configurations can also be used if desired. The triangular faces of the prism are at the edges of the optical element and can be perpendicular to normal plane.

Piece-wise rotation mirror array can be tilted to tilt angle 27 to deflect the reflected beam to a desired location. If tilt angle 27 is set to be parallel to normal plane 29, the reflected beam will be directed back toward the cylindrical lens. Greater degrees of tilt can be used to direct the reflected beam to other optical components or to a surface to be illuminated.

In one embodiment piece-wise rotation mirror array 10 is rotated so that the ridges defined by the peaks of the triangular prism element and the valleys defined by the 90 degree vertex of the faces of the prism elements is set at an angle of about 45 degrees to the long axis of the vertical bar of light at focal plane. An angle of 45 degrees is suitable in some embodiments because it provides optimal exchange between the converging/diverging light in the horizontal axis of the beam of light and the collimated light in the vertical axis of the beam of light. Other angles may be used as desired although they may include accepting greater or lesser exchange of the collimated and non-collimated paths.

In one embodiment piece-wise rotation mirror array 10 can be any shape that is larger than the vertical bar of light at focal plane 7. Particularly useful shapes include a square, a rectangle or an elliptical shape. Shapes smaller than the vertical bar may also be used in other embodiments of the invention, in order to improve the ability to focus the bar, but can result in lower power.

The spatial frequency of the ridges and valleys of the piece-wise rotation mirror array affect the degree of collimation and focusability that can be expected for reflected beam 11. One embodiment comprises piece-wise rotation mirror array 10 where the spatial distance between the peaks is about or less than the width of the vertical bar of light at focal plane 7.

Piece-wise rotation mirror array 10 can be constructed of any material that can be formed, cast, machined or otherwise manufactured to produce the substantially flat optical surfaces that reflect the light. Suitable materials are polymers such as acrylic or polycarbonate, metals or glasses.

The reflective surface 20 of piece-wise rotation mirror array 10 can be comprised of the material of the microarray itself or in one embodiment may be a coating that is deposited on the surface of a microarray formed as discussed above. The coating may be metallic, dielectric, or any other material that will reflect a desired wavelength or range of wavelengths of light. Additional or multiple coatings may be applied that will protect the coating surface from environmental damage such as oxidation or wear, or may enhance reflectivity, or provide other desired properties such as desired filtering such as band pass, long pass, short pass, etc., filtering.

As noted elsewhere, the piece-wise rotation mirror array is one embodiment of a piece-wise rotation array, which can be mirrors, prisms or other optical elements, and can be reflective or transmissive. Moreover, the piece-wise elements can be linear or pixelated or otherwise as desired, and can be rectangular, square, triangular, hexagonal, asymmetric or otherwise configured as desired. In certain embodiments, the relative angles of incidence of various surfaces of the piece-wise elements can be adjusted relative to each other to accommodate different angles of incidence, different wavelengths of light and other desired features. The piece-wise elements can also be tiltable, if desired, such that the exiting light beam can be directed to different locations, or split into different beams for different purposes, etc. The piece-wise elements can be controlled as a unit, individually, in patterns (e.g., sequential and/or complementary patterns, stationary patterns, wavelength-selective patterns).

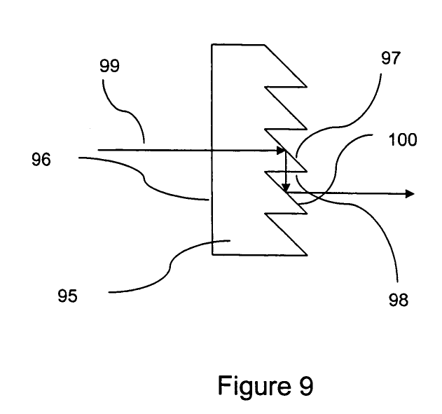

FIG. 9 depicts a side view of a schematic diagram of a transmissive optical piecewise rotational array comprising a plurality of piece-wise elements, wherein surfaces within the piece-wise elements comprise both transmissive and mirror or reflective surfaces. Transmissive piecewise rotational array 95 comprises a transmissive front surface 96 and a back surface 100 comprising an array of planar surfaces set at an angle to one another. In the embodiment depicted, the array comprises reflective surfaces 97 and a transmissive surfaces 98. Light 99 enters transmissive piecewise rotational array 95 and is transmitted to the internal surface of reflective surface 97 where it is reflected and rotated, passes through transmissive surface 98 and encounters a second reflective surface, external reflective surface 100 where it is once again reflected and rotated, propagating away from the back surface of transmissive piecewise rotational array 95.

Turning to the determination of a desired optimum angle we will consider a single facet or prism of piece-wise rotation mirror array 10.

Optimum angle can be determined by the following calculations:

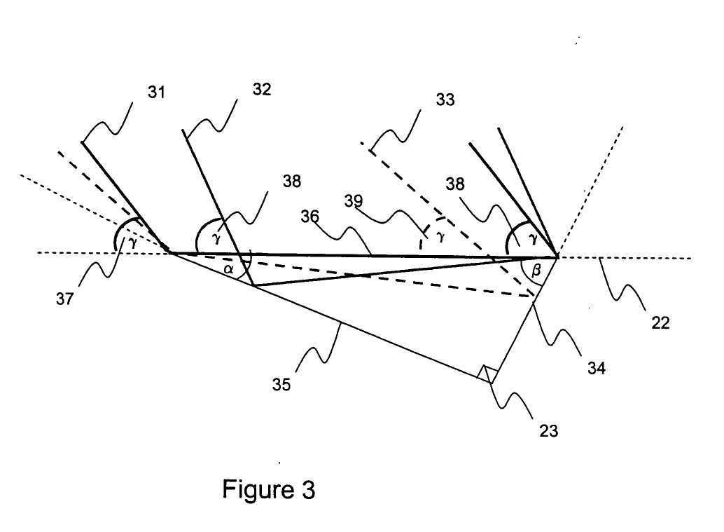

The efficiency of the retro-reflection for collimated beams parallel to the cross-section plane of the piece-wise rotation mirror array is determined with reference to FIG. 3. 100% geometrical efficiency is achieved for a collimated beam that is parallel to ray 31 whose angle 37 with plane 22 is γ=2α. In this configuration all rays hitting each prism on each of its sides are retro-reflected.

Collimated beams parallel to other directions such as 32 or 33 are reflected with less than 100% geometrical efficiency. Rays parallel to ray 32 whose angle 38 with plane 22 is γ>2α that impinge on the longer side 35 of the reflecting surfaces to the right of ray 32 are not reflected on the shorter side 34 of the reflecting surfaces and are therefore not retro-reflected. Rays parallel to ray 33 whose angle 39 with plane 22 is γ<2α that impinge on the shorter side 34 of the reflecting surfaces to the left of ray 33 are not reflected on the longer side 35 of the reflecting surfaces and are therefore not retro-reflected.

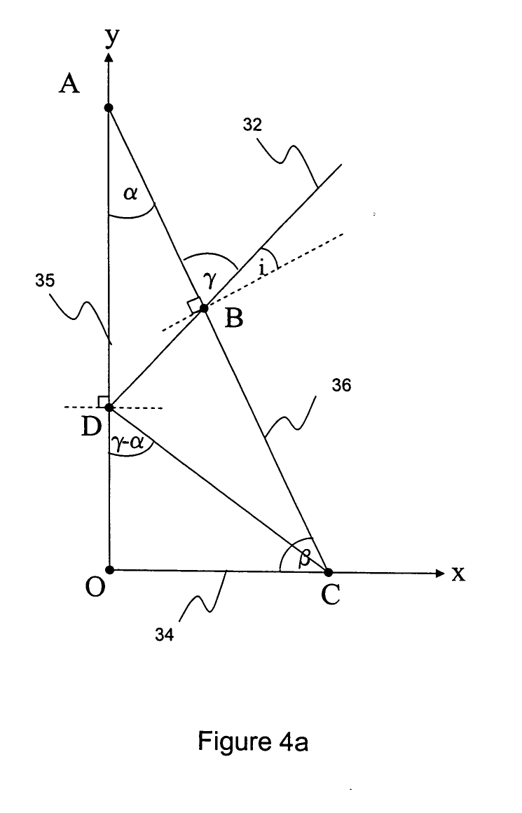

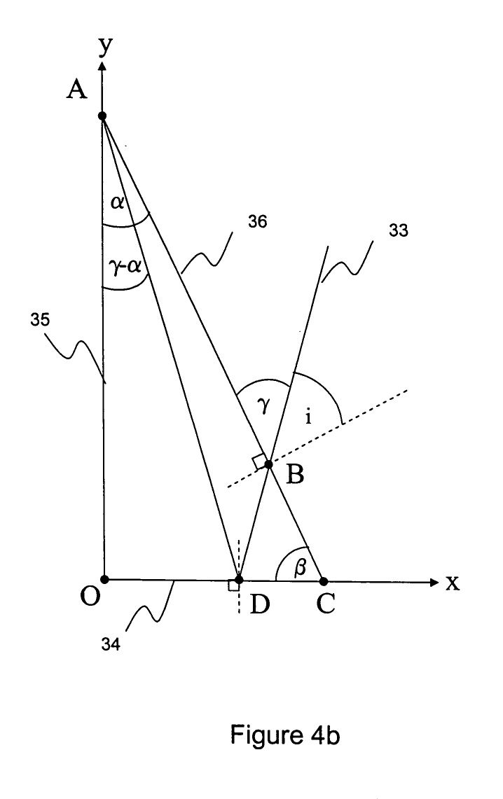

The geometrical efficiency can be derived by the following mathematical argument illustrated in FIG. 4: Assume a coordinates system that is naturally formed by the two perpendicular reflecting surfaces 34 and 35.. Let side 35 define the x-axis and let side 34 define the y-axis. The spatial separation 36 of the peaks of the microarray 10 in plane 22 forms the hypotenuse of a triangle OAC with perpendicular sides OA and OC comprised of reflecting surfaces 34 and 35. Let the length of this hypothenuse be 1.

The coordinates of the triangle corners are O=(0, 0), A=(0, cos(α)), C=(sin(α), 0). As depicted in FIG. 4a, point D where ray 32 is reflected off surface 34 has coordinates D=(sin(α)/tan(γ−α), 0).

Any rays parallel to ray 32 that cross AC between A and B will not be reflected at the second side. AB therefore represents the loss of light for a collimated beam impinging at this angle. B is the intersection of the line through A and C whose equation is

$$y = \frac{sin ( α )}{tan ( γ - α )} - tan ( γ - β ) . x$$

with the line through D and B whose equation is

$$y = cos ( α ) - \frac{x}{tan ( α )}$$

The coordinates of B=(X_{B}, Y_{B}) can therefore be calculated as

$${x}_{B} = \frac{cos ( α ) - \frac{sin ( α )}{tan ( γ - α )}}{\frac{1}{tan ( α )} - tan ( γ + β )}$$

$$and$$

$${y}_{B} = cos ( α ) - \frac{cos ( α ) - \frac{sin ( α )}{tan ( γ - α )}}{1 - tan ( α ) tan ( γ + β )}$$

The geometrical efficiency of the microarray R(γ) is therefore given by:

$$R ( γ ) = 1 - AB = 1 - \sqrt{{( {x}_{B} - {x}_{A} )}^{2} + {( {y}_{B} - {y}_{A} )}^{2}} = 1 - \sqrt{{( \frac{cos ( α ) - \frac{sin ( α )}{tan ( γ - α )}}{\frac{1}{tan ( α )} - tan ( γ + β )} )}^{2} + {( \frac{cos ( α ) - \frac{sin ( α )}{tan ( γ - α )}}{1 - tan ( α ) tan ( γ + β )} )}^{2}}$$

$$R ( γ ) = 1 - \vert \frac{cos ( α ) - \frac{sin ( α )}{tan ( γ - α )}}{\frac{1}{tan ( α )} - tan ( γ + β )} \vert \sqrt{1 + \frac{1}{{tan}^{2} ( α )}}$$

Using the trigonometric equality

$$1 + {tan}^{2} ( α ) = \frac{1}{{cos}^{2} ( α )}$$

this reduces further to

$$R ( γ ) = 1 - \vert \frac{1 - \frac{tan ( α )}{tan ( γ - α )}}{1 - tan ( α ) tan ( γ + β )} \vert$$

Since β=π/2−α and the incident angle i=π/2−γ the geometric efficiency can be expressed solely as a function of α and the angle of incident i:

$$R ( γ ) = 1 - \vert \frac{1 - tan ( α ) tan ( i + α )}{1 + tan ( α ) tan ( i + α )} \vert \qquad ( Equation 1 )$$

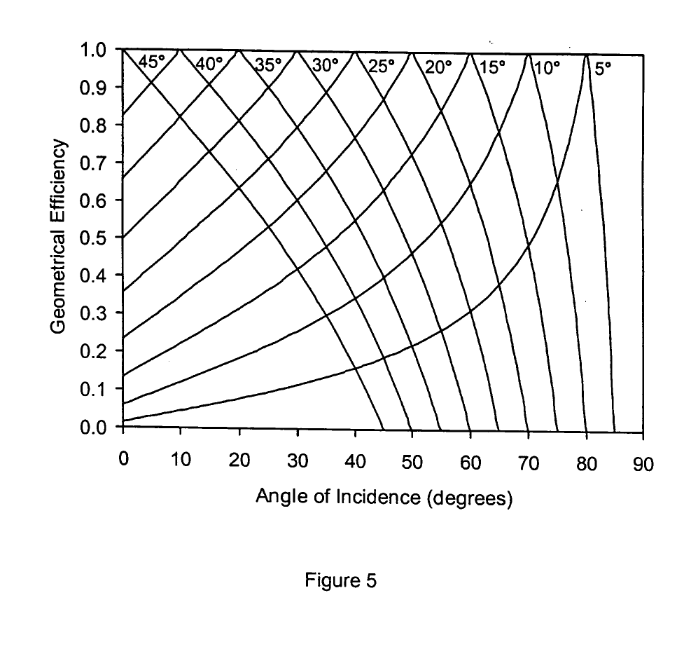

A graph of this equation is shown in FIG. 5.

This derivation of Equation 1 is valid for γ>2α, in which situation the loss of light occurs for rays hitting the longest side of the triangle first. For γ<2α, the rays that don't get retro-reflected hit the shortest side first as depicted in FIG. 4b. The coordinates of the triangle are the same as in the previous case, as is the equation for the line through A and C. Point D where ray 33 hits the first reflective surface now has coordinates D=(sin(α) tan(γ−α), 0). The equation of the line through D and B now is
y=−cos(α)−tan(γ+β)x
which leads to coordinates for B of

$${x}_{B} = \frac{2 cos ( α )}{\frac{1}{tan ( α )} - tan ( γ + β )}$$

$$and$$

$${y}_{B} = cos ( α ) - \frac{2 cos ( α )}{1 - tan ( α ) tan ( γ + β )}$$

From these the geometrical efficiently is derived in the same manner as before which yields a reesult identical to Equation 1.

Maximum efficiency R(γ)=1 is obtained for an angle of incidence or

$$i = \frac{π}{2} - 2 α \qquad ( Equation 2 )$$

The graph on FIG. 5 clearly shows these maxima.

Thus in one embodiment of the invention, falling angle 25 of piece-wise rotation mirror array 10 is derived so as to increase the efficiency according to the above equations 1 and 2.

Used as a light concentrator in conjunction with two cylindrical lenses 5 and 12, the microarray is used to rotate light about the axis of propagation within the incoming line shaped beam by 90 degrees or other angle as desired, so that the angles of propagation in the x and y directions are exchanged, but not the x and y beam sizes because each small prism only acts on a small part of the beam.

For each prism to exchange the x and y angles of divergence, it needs to be placed at 45 degrees to the x and y axes (i.e., rotated by 45 degrees about the z axis) of the first cylindrical lens 5.

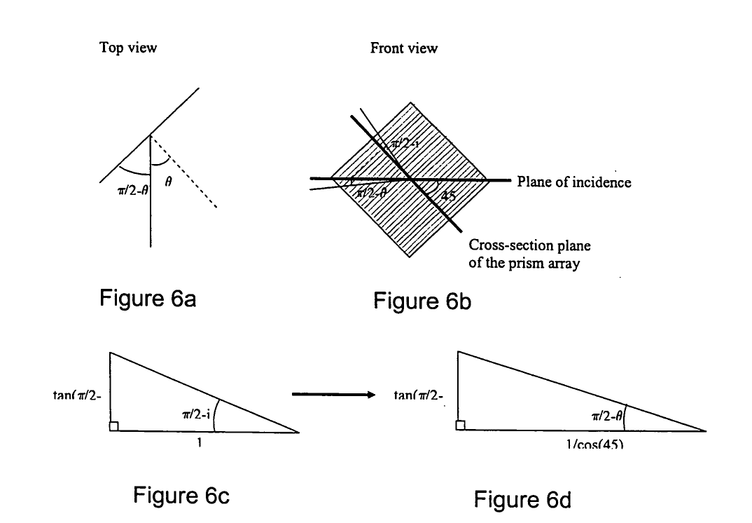

The microarray further can be rotated about the y axis so as to fold the optical path; otherwise the reflected beam will be retro-reflected back to the light source. With this rotation the angle of incidence i of the beam onto the plane of the microarray 22 projected in the cross-section of the latter is no longer equal to the global angle of incidence e of the beam onto the plane of the microarray as depicted in FIG. 6a.

The geometrical relationship between θ and i can be calculated from the projection of the right-angle triangle that defines angle π/2−i onto the plane of incidence in the direction perpendicular to the cross-section plane as illustrated in FIG. 6b. This relationship is given by

$$tan ( \frac{π}{2} - θ ) = \frac{tan ( \frac{π}{2} - i )}{\frac{1}{cos ( 45 )}}$$

which reduces to

$$\frac{π}{2} - θ = {tan}^{- 1} ( \frac{1}{\sqrt{2} tan ( i )} )$$

Thus the relationship between e, the global angle of incidence on the plane of the microarray and i, the effective angle of incidence in the cross-section of the microarray is given by

$$i = {tan}^{- 1} ( \frac{tan ( θ )}{\sqrt{2}} )$$

From this and equation 2 one can calculate the microarray angle α that provides the microarray with maximum geometrical efficiency when the beam is folded by θ:

$$α = \frac{1}{2} ( {tan}^{- 1} ( \frac{\sqrt{2}}{tan ( θ )} ) ) \qquad ( Equation 3 )$$

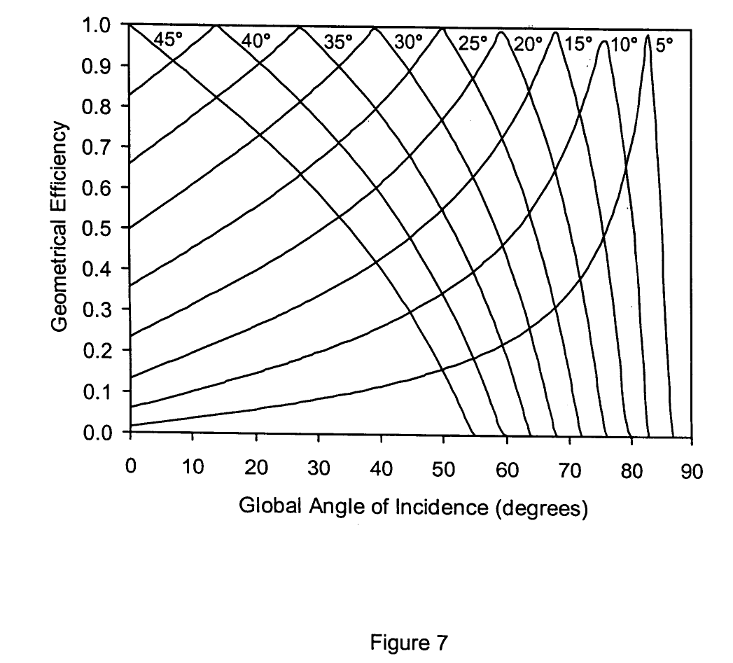

FIG. 7 is a graph of the geometrical efficiency as a function of θ and shows the maxima clearly.

In another embodiment the element that reflects and rotates the collimated and non-collimated axis of line of light at focal plane may be a prism array. Prism arrays for redirection of light are known. Performance can be improved if desired for certain applications.

Such prism arrays typically have an optically transparent, optically flat front face and a periodic array of prism elements comprising ridges and valleys similar to that discussed above for the piece-wise rotation mirror array.

In one embodiment incorporating a prism array, the prism array is oriented so that the flat surface of the array is directed toward the cylindrical lens or other suitable focusing element and positioned so that the bar of light at the focal plane impinges on the ridges and valleys of the prism array.

Light enters the prism array at the front face and is refracted depending on the angle of incidence and the wavelength of the light. This light passes through the prism material until it encounters the back face of the prism array. Here the light either passes through the surface and is refracted once again or it is reflected. Preferably very little refraction occurs and most of the light is reflected back. While this type of device will typically have more losses compared to a reflective prism array performance can be improved by improved methods to specify the angles of the planes making up the back surfaces of the prism array.

The optimum angle of these planes is determined in the same way as for piece-wise rotation mirror array and but with the angles of incidence i and θ replaced by the effective angles of incidence i′ and e′ given by Snell's law
sin(i)=n sin(i′)
hence

$${i}^{′} = {sin}^{- 1} ( \frac{sin ( i )}{n} ) \qquad ( Equation 4 )$$

Similarly

$${θ}^{′} = {sin}^{- 1} ( \frac{sin ( θ )}{n} ) . \qquad ( Equation 5 )$$

With these substitution equations 1-3 apply also to prism arrays provided an additional condition for total internal reflection is superimposed, i.e., the incident angles of the rays hitting both sides of the triangle have to be greater than the critical angle

$${sin}^{- 1} ( \frac{1}{n} ) ,$$

otherwise the efficiency drops to 0%.

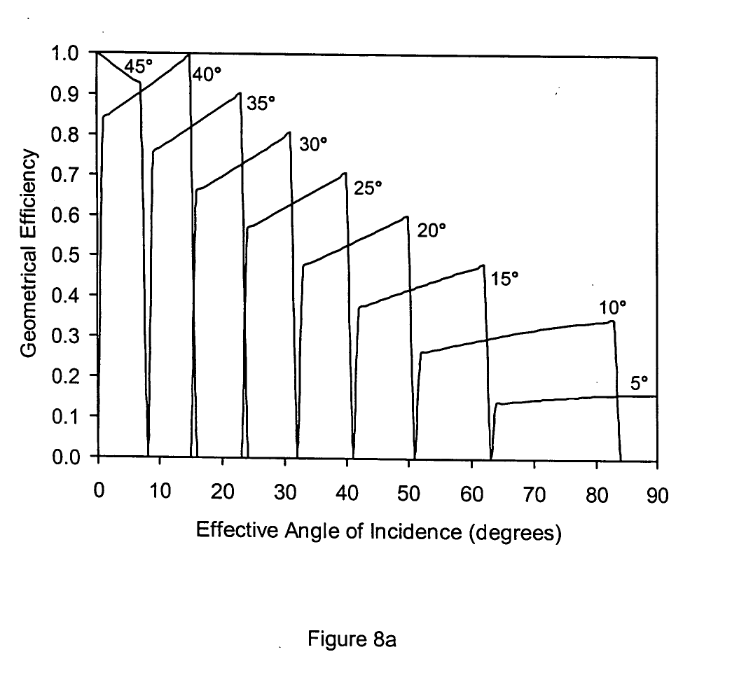

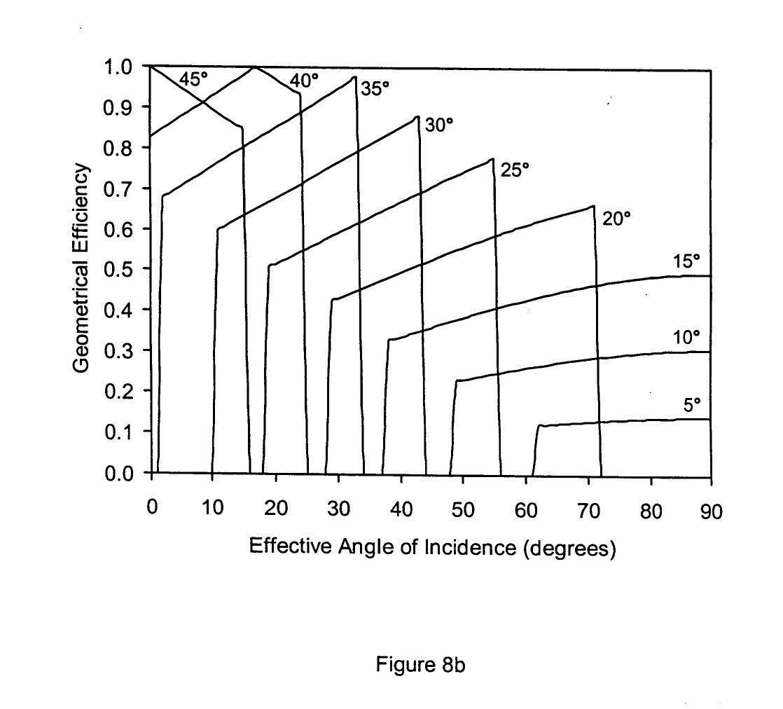

The graphs in FIG. 8 show that the efficiency of prism arrays is limited to a narrower range of incident angles than for piece-wise rotation mirror arrays and 100% efficiency can only be achieved for a limited range of prism angles a. Both these ranges can be extended somewhat by using a glass with a greater refractive index.

Rays impinging on the internal sides of the prisms no longer have a global angle of incidence on these sides that is equal to its projection in the cross-section plane; because the ray comes out of the cross-section plane, the actual angle of incidence on these sides is greater than the projection in the cross-section, which means that for a given prism profile, greater angles of incidence on the prism array will still be retro-reflected because they are still greater than the critical angle.

Because the prism array exchanges the angles, the reflected beam comes out with a 0 degree angle about the y axis (because it gets the incidence angle of the beam about the x axis, which is 0) and a θ angle about the x axis (because it gets the incidence angle of the beam about the y axis, which is θ). The folding angle about the y axis is therefore not equal to 2θ, as with a traditionnal folding mirror, but to θ only, and the prism array also folds the path about the x axis by the same

In other aspects, the present invention includes methods of making and of using the devices, systems, etc., discussed herein, and methods of making and using the unique beams of light discussed herein. For example, the present invention comprises methods of rotating a collimated light beam comprising focusing the collimated light beam substantially in only one axis to form a collimated beam having an elongated cross-section at a focal point of the focusing element, then piece-wise rotating the light beam such that collimated and non-collimated axes of the beam are changed in position to provide a rotated collimated beam that is collimated along a desired axis of the beam other than a long axis of the elongated cross-section and converging/diverging along a second desired axis of the beam other than a short axis the elongated cross-section.

The rotated collimated beam can comprises at least about 70%, 80%, 90%, 95%, 98%, or substantially all of the light of the collimated beam. The methods can further comprise collimating a non-collimated light beam to provide the collimated light beam, and providing light from a light source to provide the light beam to be collimated and rotated. The light can be from a point light source, and non-point light source, a laser, an arc lamp, an LED, or any other desired light source. The methods can also comprise filtering the light in conjunction with the collimating and/or piece-wise rotating of the light beam, and other wise treating the light beam as desired to affect the characteristics of the light beam.

All terms used herein, including those specifically discussed below in this section, are used in accordance with their ordinary meanings unless the context or definition indicates otherwise. Also unless indicated otherwise, except within the claims, the use of “or” includes “and” and vice-versa. Non-limiting terms are not to be construed as limiting unless expressly stated (for example, “including” and “comprising” mean “including without limitation” unless expressly stated otherwise).

The scope of the present invention includes both means plus function and step plus function concepts. However, the terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in mehod or process claims as indicating a “step plus function” relationship unless the word “step” is specifically recited in the claims, and are to be interpreted in the claims as indicating a “step plus function” relationship where the word “step” is specifically recited in a claim.

From the foregoing, it will be appreciated that, although specific embodiments of the invention have been discussed herein for purposes of illustration, various modifications may be made without deviating from the spirit and scope of the invention. Accordingly, the invention includes such modifications as well as all permutations and combinations of the subject matter set forth herein and is not limited except as by the appended claims.

1. An optical concentrator comprising a plurality of optical elements optically connected along a light path, the elements comprising a focusing element configured to focus collimated light substantially in only one axis to form a beam having an elongated cross-section at a focal point of the focusing element, the focusing element located upstream from a piece-wise rotation optical element configured to rotate in a piece-wise manner at least a substantial portion of the beam such that collimated and non-collimated axes of the beam are changed in position to provide a beam that is collimated along a desired axis of the beam other than the long axis and converging/diverging along a second desired axis of the beam other than the short axis.

2. The optical concentrator of claim 1 further comprising a collimator located upstream from focusing element.

3. The optical concentrator of claim 1 wherein the piece-wise rotation optical element is configured to rotate the substantial portion approximately 90 degrees such that the collimated and non-collimated axes are exchanged in position to provide a beam that is collimated along the short axis of the beam and converging/diverging along the long axis of the beam.

4. The optical concentrator of claim 1 wherein the piece-wise rotation optical element comprises an array of first surface reflectors configured as approximately 90 degree retro-reflectors.

5. The optical concentrator of claim 1 wherein the piece-wise rotation optical element comprises an array of prisms configured as porro type approximately 90 degree retro-reflectors.

6. (Currently Amended) The optical concentrator of claim 5 wherein the piece-wise rotation optical element has an about 90 degree vertex of the retro-reflector, which is set at approximately 45 degrees to the collimated axis of the focused beam directed onto the array.

7. The optical concentrator of claim 1 wherein the piece-wise rotation optical element is tilted to direct the reflecting beam away from the source of illumination.

8. The optical concentrator of claim 1 further comprising a second focusing element downstream from the rotation optical element, the second focusing element configured to focus a light beam emitted from the piece-wise rotation optical element to form a narrow line.

9. The optical concentrator of claim 1 further comprising an optical shaping element downstream from the rotation optical element, the optical shaping element configured to spread a light beam emitted from the piece-wise rotation optical element to form a narrow substantially rectangular shaped beam.

10. The optical concentrator of claim 1 further comprising a scanner configured to scan a light beam emitted from the piece-wise rotation optical element to illuminate a target.

11. The optical concentrator of claim 1 further comprising a scanner configured to scan a light beam emitted from the piece-wise rotation optical element to a different optical system.

12. The optical concentrator of claim 1 wherein the piece-wise rotation optical element comprises a transparent prism array wherein a flat surface of the prism is directed toward the source of illumination and a back surface of the prism comprises triangular surface elements.

13. The optical concentrator of claim 1 wherein the piece-wise rotation optical element is substantially flat.

14. The optical concentrator of claim 1 wherein the piece-wise rotation optical element is substantially curved.

15. The optical concentrator of claim 1 wherein at least two of the optical elements are combined into a single unit.

16. A lighting system that provides a light beam having a long axis and a short axis and that is collimated along a desired axis of the beam other than the long axis and converging/diverging along a second desired axis of the beam other than the short axis, the system comprising:
a) a light source configured to provide a light beam;
b) a first optical element disposed and configured to accept and collimate the light beam to provide a collimated light beam;
c) a second optical element disposed and configured to focus the collimated light beam substantially in only one axis to form a substantially line-shaped beam; and,
d) a third optical element disposed and configured to configured to rotate at least a substantial portion of the substantially line-shaped beam a desired number of degrees such that the collimated and non-collimated axes are changed in position to provide a beam that is collimated along a desired axis of the beam other than the long axis and converging/diverging along a second desired axis of the beam other than the short axis.

17. The lighting system of claim 15 wherein the third optical element is configured to rotate the substantial portion approximately 90 degrees.

18. The lighting system of claim 15 wherein the light source is a point light source.

19. The lighting system of claim 17 wherein the point light source comprises an arc lamp disposed upstream from an aperture stop.

20. The lighting system of claim 15 wherein the third optical element comprises an array of first surface reflectors configured as approximately 90 degree retro-reflectors.

21. The lighting system of claim 15 wherein the third optical element comprises an array of prisms configured as porro type approximately 90 degree retro-reflectors.

22. The lighting system of claim 20 or 21 wherein the third optical element has an about 90 degree vertex of the retro-reflector, which is set at approximately 45 degrees to the collimated axis of the focused beam directed onto the array.

23. The lighting system of claim 15 wherein the third optical element is tilted to direct the reflecting beam away from the source of illumination.

24. The lighting system of claim 15 further comprising a fourth optical element downstream from the third optical element, the fourth optical element configured to focus the light beam emitted from the third optical element to form a narrow line.

25. The lighting system of claim 15 further comprising an optical shaping element downstream from the third optical element, the optical shaping element configured to spread the light beam emitted from the third optical element to form a narrow substantially rectangular shaped beam.

26. The lighting system of claim 15 further comprising a scanner configured to scan the light beam emitted from the third optical element to illuminate a target.

27. The lighting system of claim 15 further comprising a scanner configured to scan the light beam emitted from the third optical element to a different optical system.

28. The lighting system of claim 15 wherein the third optical element comprises a transparent prism array wherein a flat surface of the prism is directed toward the source of illumination and a back surface of the prism comprises triangular surface elements.

29. The lighting system of claim 15 wherein the third optical element is substantially flat.

30. The lighting system of claim 15 wherein the third optical element is substantially curved.

31. The lighting system of claim 15 wherein at least two of the optical elements are combined into a single unit.

32. A light beam from a system according to any one of claims 1-4, or 16-19.

33. A treated light beam from a light source, and the treated beam having a substantially elongated cross-section comprising a short first axis and a long second axis, wherein the beam is collimated along a desired axis of the beam other than the long axis and converging/diverging along a second desired axis of the beam other than the short axis, and wherein the light beam comprises substantially all of the light emanated from the light source along the light beam.

34. The light beam of claim 32 or 33 wherein the axes are at 90° to each other and the beam is collimated along the short axis and converging/diverging along the long axis.

35. The light beam of claim 32 or 33 wherein the long axis exceeds the short axis by a ratio of at least about 10.

36. The light beam of claim 32 or 33 wherein the long axis exceeds the short axis by a ratio of at least about 100.

37. An optical piece-wise mirror rotation array comprising an array of piece-wise rotation mirror elements configured such that light impinging on a front surface of the array is piece-wise rotated by the array of piece-wise mirror elements then emitted from the front surface of the array.

38. An optical piece-wise transmissive rotation array comprising an array of piece-wise rotation elements configured such that light impinging on a front surface of the array is piece-wise rotated by the piece-wise elements then emitted from at least one of a back surface and a side surface of the array.

39. The optical piece-wise rotation array of claim 39 wherein the light is emitted from the back surface of the array.

40. The optical piece-wise rotation array of claim 39 wherein piece-wise rotation elements comprise first surface mirrors.

41. The optical piece-wise rotation array of claim 39 wherein piece-wise rotation elements comprise transmissive prisms.

42. The optical piece-wise rotation array of claim 39 wherein piece-wise rotation elements comprise both first surface mirrors and transmissive prisms.

43. The optical piece-wise rotation array of claim 37 or 38 wherein the piece-wise elements are substantially linearly shaped.

44. The optical piece-wise rotation array of claim 37 or 38 wherein the piece-wise elements are substantially rectangular.

45. The optical piece-wise rotation array of claim 37 or 38 wherein the piece-wise elements are substantially square.

46. The optical piece-wise rotation array of claim 37 or 38 wherein the piece-wise elements are substantially triangular or hexagonal.

47. The optical piece-wise rotation array of claim 37 or 38 wherein the piece-wise elements are asymmetric.

48. The optical piece-wise rotation array of claim 37 or 38 wherein the piece-wise elements comprise a protective coating.

49. The optical piece-wise rotation array of claim 37 or 38 wherein the piece-wise elements comprise a filter coating.

50. The optical piece-wise rotation array of claim 49 wherein the filter coating is configured to substantially block short wavelengths of electromagnetic radiation.

51. The optical piece-wise rotation array of claim 49 wherein the filter coating is configured to substantially block long wavelengths of electromagnetic radiation.

52. The optical piece-wise rotation array of claim 49 wherein the filter coating is configured to pass substantially only a single wavelength or wavelength band of electromagnetic radiation.

53. The optical piece-wise rotation array of claim 37 or 38 wherein the piece-wise rotation array piece-wise rotates the light by about 90°.

54. The optical piece-wise rotation array of claim 37 or 38 wherein the piece-wise elements are tiltable.

55. The optical piece-wise rotation array of claim 3837 or 38 wherein surfaces within the piece-wise elements are adjustable relative to each other.

56. The optical piece-wise rotation array of claim 37 or 38 wherein the array is operably connected to a computer comprising computer-implemented programming, the programming configured to control the piece-wise elements at least one of as a unit, individually, or in patterns.

57. The optical piece-wise rotation array of claim 56 wherein the patterns are sequential, complementary patterns.

58. The optical piece-wise rotation array of claim 56 wherein the patterns are stationary patterns.

59. A method of rotating a collimated light beam comprising focusing the collimated light beam substantially in only one axis to form a collimated beam having an elongated cross-section at a focal point of the focusing element, then piece-wise rotating the light beam such that collimated and non-collimated axes of the beam are changed in position to provide a rotated collimated beam that is collimated along a desired axis of the beam other than a long axis of the elongated cross-section and converging/diverging along a second desired axis of the beam other than a short axis the elongated cross-section.

60. The method of claim 59 wherein the rotated collimated beam comprises at least about 90 % of the light of the collimated beam.

61. The method of claim 59 wherein the rotated collimated beam comprises substantially all of the light of the collimated beam.

62. The method of claim 59 wherein the method further comprises collimating a non-collimated light beam to provide the collimated light beam.

63. The method of claim 59 wherein the method further comprises providing light from a light source to provide the light beam.

64. The method of claim 59 wherein the method further comprises providing light from a point light source to provide the light beam.

65. The method of claim 59 wherein the method further comprises providing light from a laser to provide the light beam.

66. The method of claim 59 wherein the method further comprises providing light from at least one of an arc lamp or an LED to provide the light beam.

67. A method for enhancing the performance of a first surface reflector reflective piecewise rotational array when the beam is to be folded by an angle θ comprising determing suitable angles of the reflecting planes of the array by calculating the microarray angle α according to the equation:
$$α = \frac{1}{2} ( {tan}^{- 1} ( \frac{\sqrt{2}}{tan ( θ )} ) ) .$$

68. A method for enhancing the performance of a total internal reflectance prism type reflective piecewise rotational array when the beam is to be folded by an angle θ comprising determing suitable angles of the reflecting planes of the array by calculating the microarray angle α according to the equation,
$$α = \frac{1}{2} ( {tan}^{- 1} ( \frac{\sqrt{2}}{tan ( θ )} ) )$$
where the angle θ is replaced in the calculation by the effective angle θ′ for the prism material determined by the equation
$${θ}^{′} = {sin}^{- 1} ( \frac{sin ( θ )}{n} ) .$$
